(19) United States
(12) Patent Application Publication
(10) Pub. No.: US 2026/0135384 A1
(43) Pub. Date: May 14, 2026

(54) METHOD AND SYSTEM FOR PARTICIPATING IN GRID FREQUENCY REGULATION WITHIN FULL RANGE OF CHARGING AND DISCHARGING OF ENERGY STORAGE

(71) Applicant: Guizhou Power Grid Co., Ltd., Guiyang (CN)

(72) Inventors: Xiankui WEN, Guiyang (CN); Qiang FAN, Guiyang (CN); Huayang YE, Guiyang (CN); Shihai ZHANG, Guiyang (CN); Mian WANG, Guiyang (CN); Junwei ZHANG, Guiyang (CN); Peng ZENG, Guiyang (CN); Jingliang ZHONG, Guiyang (CN); Lingrong PANG, Guiyang (CN); Changbao XU, Guiyang (CN); Bowen LI, Guiyang (CN); Rong ZENG, Guiyang (CN); Junkai HUANG, Guiyang (CN); Tingyun GU, Guiyang (CN); Lei FAN, Guiyang (CN); Yuanyuan CHEN, Guiyang (CN); Jianrong WU, Guiyang (CN); Tao YANG, Guiyang (CN); Zujiang LIAO, Guiyang (CN); Yang ZHANG, Guiyang (CN); Xinyi FU, Guiyang (CN); Xin LUO, Guiyang (CN); Qili ZHANG, Guiyang (CN); Shuzhou XIAO, Guiyang (CN); Tiansong HU, Guiyang (CN)

(21) Appl. No.: 19/441,157

(22) Filed: Jan. 6, 2026

Related U.S. Application Data
(63) Continuation of application No. PCT/CN2025/072981, filed on Jan. 17, 2025.

(30) Foreign Application Priority Data
Mar. 29, 2024 (CN) 202410372968.0

(51) Int. Cl. H02J 3/0014; H02J 3/32; H02J 13/183; H02J 103/35

(52) U.S. Cl. CPC H02J 3/00142; H02J 3/32; H02J 13/183; H02J 2103/35

(57) ABSTRACT

The present invention discloses a method and system for participating in grid frequency regulation within full range of charging and discharging of energy storage, comprising: collecting grid operation power and frequency data, and constructing a full-range droop coefficient; setting constraints of upper and lower limits of a frequency deadband, obtaining an actual output power command value based on the constraint function constructed from a theoretical power command value and a rated charging and generating power value, and controlling operation of the grid; and setting a hysteresis interval on the power command of an energy storage system, wherein when the demand of the grid exceeds the upper threshold, the energy storage system switches from the charging mode to the discharging mode; and when the demand of the grid falls below the lower threshold, the energy storage system switches from the discharging mode to the charging mode.

### CROSS-REFERENCE TO RELATED APPLICATIONS

The present application is a continuation of International Application No. PCT/CN2025/072981, filed on Jan. 17, 2025, which claims priority to Chinese Patent Application No. 202410372968.0, filed on Mar. 29, 2024, the entire disclosure of which is incorporated herein by reference.

### TECHNICAL FIELD

The present invention relates to the technical field of energy storage, and particularly to a method and system for participating in grid frequency regulation within full range of charging and discharging of energy storage.

### BACKGROUND

An energy storage system is an important component of a power system, and is mainly used for storing surplus electric energy and releasing the stored energy when required. In a grid, the energy storage phase and the energy release phase of the energy storage system are generally carried out separately. During the energy storage phase, when the supply of electric energy in the grid exceeds the demand, the energy storage system will store the surplus electric energy. During the energy release phase, when the demand for electric energy in the grid exceeds the supply, the energy storage system will release the stored electric energy so as to meet the demand of the grid.

In a power system, the stability of the frequency is one of the key indicators for ensuring stable operation of the system. The frequency of the grid is required to be maintained within a certain range. For example, in China, the standard frequency of the grid is 50 Hz, with an tolerable deviation range typically being plus or minus 0.2 Hz. In order to maintain the stability of the frequency, grid operators will implement frequency regulation services, which include primary frequency regulation, secondary frequency regulation, and tertiary frequency regulation. As a flexible regulating resource, the energy storage system can respond to the frequency regulation demand of the grid by storing and releasing energy. However, conventional energy storage systems perform the energy storage (charging) phase and the energy release (discharging) phase separately, and participate in grid frequency regulation control only during the energy release (discharging) phase, resulting in issues of smaller load regulation scope and insufficient support to the grid.

### SUMMARY

In view of the above issues, the present invention is provided.

Accordingly, the technical problem to be solved by the present invention is how to enable both a charging system and a discharging system of an energy storage system to simultaneously participate in grid frequency regulation control. By constructing a full-range droop coefficient and a charge-discharge operation mode, full-range power regulation of the energy storage system in response to variations in grid frequency is achieved.

To solve the above technical problem, the present invention provides the following technical scheme: a method for participating in grid frequency regulation within full range of charging and discharging of energy storage, comprising:
collecting grid operation power and frequency data, and constructing a full-range droop coefficient;
setting constraints of upper and lower limits of a frequency deadband, obtaining a power regulation value according to the range of the real-time frequency, and calculating a theoretical power command value;
obtaining an actual output power command value based on the constraint function constructed from a theoretical power command value and a rated charging and generating power value, and controlling the operation of the grid according to the actual output power command value; and
setting a hysteresis interval on the power command of an energy storage system, wherein when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

As a preferred scheme of the method for participating in grid frequency regulation within the full range of charging and discharging of energy storage in the present invention, wherein constructing the full-range droop coefficient comprises: collecting upper and lower limits of the grid operation frequency, recording rated generating power value of a generator and rated charging power value of a motor, and calculating the full-range droop coefficient, expressed by the formula as follows:

$$∈ = \frac{{\int }_{{f}_{d}}^{{f}_{u}} {e}^{∝ ( f - {f}_{ε} ) df}}{{P}_{g} + {\sum }_{n = 1}^{N} \frac{{P}_{S}}{1 + {e}^{- β ( {f}_{n} - {f}_{0} )}}}$$

wherein ϵ represents the full-range droop coefficient; P_{g} represents the rated generating power value; Pₛ represents the rated charging power value; fᵤ represents the upper limit of the frequency; f_{d} represents the lower limit of the frequency; f represents the current grid frequency; f_{ε} represents
the frequency deviation from the rated frequency; e^{∝(f-f}^{₀}⁾ represents the regulation sensitivity; α represents the parameter regulating the growth rate of the exponential function;

$$\frac{{P}_{S}}{1 + {e}^{- β ( {f}_{n} - {f}_{0} )}}$$

represents the normalization function, simulating the nonlinear characteristic of the charging power varying with frequency; fₙ represents the frequency value of the segment n; and β represents the parameter regulating the steepness of the curve.

As a preferred scheme of the method for participating in grid frequency regulation within the full range of charging and discharging of energy storage in the present invention, wherein the obtaining of the power regulation value comprises a power regulation value retrieval function constructed using a real-time grid frequency value and a rated grid frequency value, with upper and lower limits of the frequency deadband as the constraint condition, expressed by the formula as follows:

$$Δ P = \{ \begin{matrix}ϵ \times \frac{{f}_{r} - {f}_{0}}{{f}_{0}} \times {P}_{g} & {f}_{r} > {Δ}_{u} \\ 0 & {Δ}_{u} > {f}_{r} > {Δ}_{d} \\ ϵ \times \frac{{f}_{r} - {f}_{0}}{{f}_{0}} \times {P}_{s} & {Δ}_{d} > {f}_{r}\end{matrix}$$

wherein ΔP represents the power regulation value; fᵣ represents the real-time frequency value; f₀ represents the rated frequency value; Δᵤ represents the upper limit of the frequency deadband; Δ_{d} represents the lower limit of the frequency deadband;
when value of ΔP is positive, the power is increased; and when the value of ΔP is negative, the power is decreased.

As a preferred scheme of the method for participating in grid frequency regulation within the full range of charging and discharging of energy storage in the present invention, wherein the obtaining of actual output power command value comprises: obtaining the actual output power command value based on a constraint function constructed from the theoretical power command value and the rated generating and charging power value, and controlling the grid operation according to the actual output power command value;
the formula for calculating the theoretical power command value being expressed as:

$${P}_{c} = Δ P + {P}_{r}$$

wherein P_{c} represents the theoretical power command value; and Pᵣ represents the real-time power value;
and performing determination to obtain the real output power command value, expressed by the formula as follows:

$${{P}_{c}}^{′} = \{ \begin{matrix}{P}_{g} & {P}_{c} > {P}_{g} \\ Δ P + {P}_{r} & {P}_{g} > {P}_{c} > {P}_{s} \\ {P}_{s} & {P}_{s} > {P}_{c}\end{matrix}$$

wherein P_{c}′ represents the actual output power command value; when the value of P_{c}′ is positive, the energy storage system enters a discharging state, and the system outputs power P_{c}′ externally; when the value of P_{c}′ is negative, the energy storage system enters a charging state, and the system consumes power |P_{c′}| externally.

As a preferred scheme of the method for participating in grid frequency regulation within the full range of charging and discharging of energy storage in the present invention, wherein the upper and lower limits of the frequency are predetermined according to the design standards of the grid and the requirements for stable operation; the specific method comprises: determining the standard operation frequency of the grid according to the preset regional standards; calculating the tolerable frequency deviation range of the grid; and setting an upper limit and a lower limit of the frequency accordingly;
the upper limit of the grid frequency being expressed by the formula as follows:

$${f}_{u} = {f}_{0} + ( Δ f + Λ {\sum }_{n = 1}^{N} {a}_{n} cos ( \frac{2 π nt}{T} + {ϕ}_{n} ) ) \cdot ( 1 + \frac{Γ ( {f}_{0} , L , C )}{1 + {e}^{- k ( L - {L}_{c} )}} )$$

the lower limit of the grid frequency being expressed by the formula as follows:

$${f}_{d} = {f}_{0} - ( Δ f + Λ {\sum }_{n = 1}^{N} {a}_{n} cos ( \frac{2 π nt}{T} + {ϕ}_{n} ) ) \cdot ( 1 + \frac{Γ ( {f}_{0} , L , C )}{1 + {e}^{- k ( L - {L}_{c} )}} )$$

wherein f₀ represents the standard operation frequency of the grid as determined by the preset regional standards; Δf represents the basic frequency deviation range; Λ and aₙ represents the coefficients of the Fourier series, and is used for simulating the periodic regulation of the grid frequency caused by seasonal load variations; t represents the current measuring moment of the operation frequency; T represents the period duration; φₙ represents the phase shift, simulating the influence of different seasonal variations; L represents the real-time load; L_{c} represents the critical load value; C represents the proportion of renewable energy contribution in the current grid; and Γ(f₀,L,C) represents the chaotic mapping function, reflecting the combined influence of grid load and renewable energy contribution on frequency regulation;
the chaotic mapping function Γ being expressed by the formula as follows:

$$Γ ( {f}_{0} , L , C ) = {f}_{0} \cdot ( 1 - \frac{L}{{L}_{max}} ) \cdot ( 1 - C )$$

wherein Lₘₐₓ represents the maximum load that the grid can withstand.

As a preferred scheme of the method for participating in grid frequency regulation within the full range of charging and discharging of energy storage in the present invention, wherein the hysteresis interval comprises a hysteresis interval further set on the power command of the energy storage system, the hysteresis interval defining a range within which the energy storage system does not respond to minor variations in power demand of the grid when switching between charging and discharging states, thereby avoiding frequent charge-discharge switching.
the threshold of the hysteresis interval being predetermined according to the normal operation conditions of the grid and the performance characteristics of the energy storage system, and the hysteresis interval being defined by setting two power thresholds, i.e., an upper threshold of the hysteresis interval for discharging and a lower threshold of the hysteresis interval for charging;
the upper limit threshold of the discharging hysteresis interval being expressed by the formula as follows:

$${P}_{up} = {P}_{b} + δ \cdot ( 1 + \frac{sin ( w \cdot {t}_{0} + ϕ )}{1 + {e}^{- k \cdot ( P - {P}_{cr} )}} )$$

the lower threshold of the charging hysteresis interval being expressed by the formula as follows:

$${P}_{low} = {P}_{b} - δ \cdot ( 1 + \frac{sin ( w \cdot {t}_{0} + ϕ )}{1 + {e}^{- k \cdot ( P - {P}_{cr} )}} )$$

wherein P_{b} represents the power reference value of the energy storage system when no regulation is required; δ represents the power regulation sensitivity coefficient set according to changes in grid demand; sin(w·t₀+φ) represents the periodic variation factor, w represents the angular frequency, t₀ represents the current time, φ represents the phase difference, simulating the periodic variation of the grid load; k represents the regulation coefficient for nonlinear response; P represents the current power demand; and P_{cr} represents the critical power demand that triggers the power regulation response;
wherein when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

As a preferred scheme of the method for participating in grid frequency regulation within the full range of charging and discharging of energy storage in the present invention, wherein the energy storage system maintains the current charging and discharging state within the hysteresis interval, and does not respond to minor fluctuations in power demand of the grid;
when the power demand variation beyond the hysteresis interval is reached, the energy storage system smoothly switches between charging and discharging states at a predetermined rate, thus avoiding impact to the grid.

A system for participating in full range of charging and discharging of energy storage, wherein
a data acquisition module, used for collecting data from real-time grid monitoring equipment, including grid frequency and the current power state of the energy storage system, the data being transmitted in real time to a data processing and analysis module;
a data processing and analysis module, used for processing and analyzing the collected data; calculating the full-range droop coefficient in real time and determining whether the energy storage system needs to adjust the power output to respond to changes in grid frequency at the moment. The module also calculates the theoretical power command value of the energy storage system under given conditions.
a control unit module, used for determining the optimal charging and discharging strategy based on information provided by the data processing and analysis module, including how to smoothly switch the charging and discharging states of the energy storage system; the control strategy taking into account the actual grid demand, performance limitations of the energy storage system, and grid stability requirements; and
an energy storage and generation module, an executing module being used for adjusting the actual charging and discharging states of an energy storage system based on the command of a control strategy module, including adjusting the output power of an inverter connected to the grid and managing the energy flow in the energy storage system.

A computer device, comprising a memory and a processor, wherein the memory stores a computer program, wherein the processor implements the steps in the method in the present invention.

A computer-readable storage medium, on which a computer program is stored, wherein the computer program, when executed by the processor, implements the steps in the method in the present invention.

The present invention has the beneficial effects as follows: a charging system and a discharging system of energy storage simultaneously participate in grid frequency regulation control, a full-range droop coefficient is constructed, and the charge-discharge full-range power change in response to variations in grid frequency is achieved by regulating the system operation mode. When the grid frequency increases, the generating power is reduced until power is absorbed from the grid; when the grid frequency decreases, the power absorption from the grid is reduced until power is delivered to the grid. Thus, full-range participation in grid frequency regulation control is realized, and the regulation requirements of the grid are met.

### BRIEF DESCRIPTION OF DRAWINGS

In order to more clearly illustrate the technical schemes of the embodiments of the present invention, the following will briefly introduce the drawings required in the embodiments. Apparently, the drawings described below are merely some embodiments of the present invention, for a common person skilled in the art, other drawings can also be obtained according to these drawings without creative labor. In the drawings:

FIG. 1 is an overall flowchart of the method for participating grid frequency regulation within in full range of charging and discharging of energy storage provided in the first embodiment of the present invention;

FIG. 2 is a flowchart of a charge-discharge switching method of the method for participating in grid frequency regulation within full range of charging and discharging of energy storage provided in the first embodiment of the present invention; and

FIG. 3 is a schematic diagram of the method for participating in grid frequency regulation within full range of charging and discharging of energy storage provided in the first embodiment of the present invention.

### DETAILED DESCRIPTION OF THE EMBODIMENTS

In order to make the above objects, features and advantages of the present invention more obvious and easy to understand, the detailed description of the present invention will be illustrated in details below in conjunction with the drawings of the specification. Clearly, the described embodiments are part of the embodiments of the present invention, but not all. On the basis of the examples of the present invention, all other examples obtained by those of ordinary skill in the art without creative efforts shall fall within the protection scope of the present invention.

### Example 1

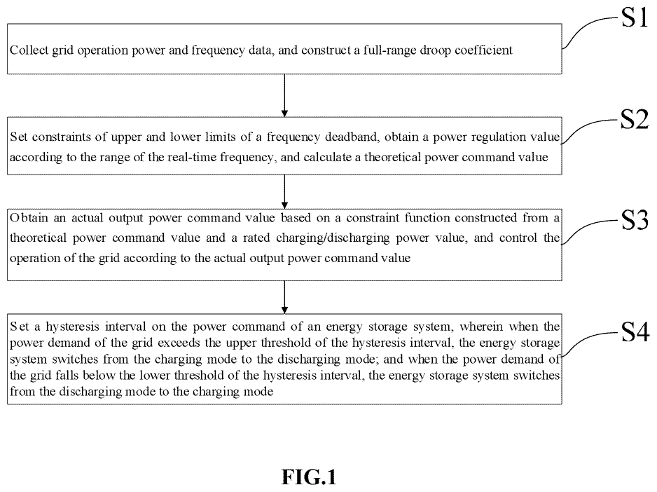

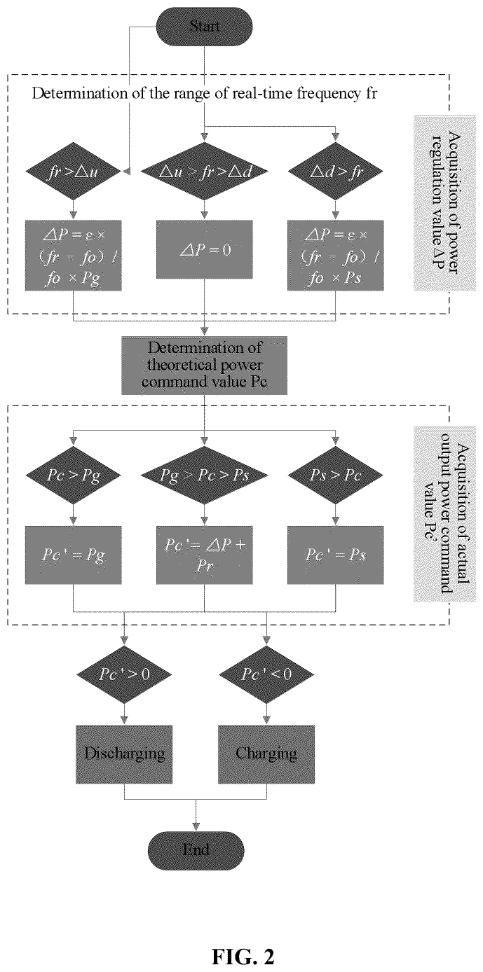

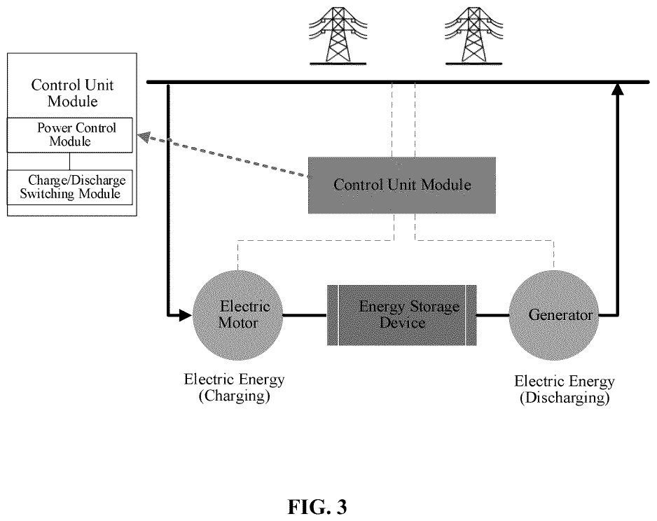

Referring to FIGS. 1-3, a first embodiment of the present invention provides a method for participating in grid frequency regulation within full range of charging and discharging of energy storage, comprising

S1: collecting grid operation power and frequency data, and constructing a full-range droop coefficient.

Further, collecting grid operation power and frequency data comprises,

Further, constructing the full-range droop coefficient comprises: collecting upper and lower limits of the grid operation frequency, recording rated generating power value of a generator and rated charging power value of a motor, and calculating the full-range droop coefficient, expressed by the formula as follows:

$$ϵ = \frac{{\int }_{{f}_{d}}^{{f}_{u}} {e}^{∝ ( f - {f}_{ε} )} df}{{P}_{g} + {\sum }_{n = 1}^{N} \frac{{P}_{S}}{1 + {e}^{- β ( {f}_{n} - {f}_{0} )}}}$$

wherein ϵ represents the full-range droop coefficient; P_{g} represents the rated generating power value; Pₛ represents the rated charging power value; fᵤ represents the upper limit of the frequency; f_{d} represents the lower limit of the frequency; f represents the current grid frequency; f_{ε} represents
the frequency deviation from the rated frequency; e^{∝(f-f}^{₀}⁾ represents the regulation sensitivity; α represents the parameter regulating the growth rate of the exponential function;

$$\frac{{P}_{S}}{1 + {e}^{- β ( {f}_{n} - {f}_{0} )}}$$

represents the normalization function, simulating the nonlinear characteristic of the charging power varying with frequency; fₙ represents the frequency value of the segment n; and β represents the parameter regulating the steepness of the curve.

Further, constructing the full-range droop coefficient: the core of the step lies in that the full-range droop coefficient is constructed based on the real-time demand of the grid and predetermined operation parameters (for example, the upper and lower limits of the frequency, and the rated power values of the generator and the motor). The coefficient can reflect how the energy storage system should regulate the charging and discharging behavior thereof under the current grid condition so as to maintain stability of the grid frequency. The innovativeness of the coefficient is that both the charging and discharging processes of the energy storage system are taken into account in a unified manner, so that the system is allowed to flexibly respond to changes in grid demand across the entire power range.

It should be noted that collecting the grid operation power and frequency data is the basis for achieving precise frequency regulation. The current demand of the grid can be promptly and accurately obtained by monitoring the operation state of the grid in real time, and direct data support is provided for the regulation of the energy storage system. The energy storage system can rapidly regulate the output power, based on the calculated full-range droop coefficient, when the grid frequency exceeds the normal operation range, in a smooth and responsive manner, whether by increasing discharge or by reducing charge. The regulation mechanism not only improves the stability of the grid but also enhances the adaptability of the grid to unexpected events;

S2: setting constraints of upper and lower limits of the frequency deadband, obtaining a power regulation value according to the range of the real-time frequency, and calculating a theoretical power command value.

Further, the power regulation value comprises a power regulation value retrieval function constructed using a real-time grid frequency value and a rated grid frequency value, with upper and lower limits of the frequency deadband as the constraint condition, expressed by the formula as follows:

$$Δ P = \{ \begin{matrix}ϵ \times \frac{{f}_{r} - {f}_{0}}{{f}_{0}} \times {P}_{g} & {f}_{r} > {Δ}_{u} \\ 0 & {Δ}_{u} > {f}_{r} > {Δ}_{d} \\ ϵ \times \frac{{f}_{r} - {f}_{0}}{{f}_{0}} \times {P}_{s} & {Δ}_{d} > {f}_{r}\end{matrix}$$

wherein ΔP represents the power regulation value; fᵣ represents the real-time frequency value; f₀ represents the rated frequency value; Δᵤ represents the upper limit of the frequency deadband; Δ_{d} represents the lower limit of the frequency deadband.

Further, when value of ΔP is positive, the power is increased; when the value of ΔP is negative, the power is decreased.

Further, the actual output power command value comprises obtaining the actual output power command value based on a constraint function constructed from a theoretical power command value and a rated charging/discharging power value, and controlling the operation of the grid according to the actual output power command value.

Further, calculating the theoretical power command value is expressed by the formula as follows:

$${P}_{c} = Δ P + {P}_{r}$$

wherein P_{c} represents the theoretical power command value; Pᵣ represents the real-time power value.

Further, determination is performed to obtain the actual output power command value, expressed by the formula as follows:

$${{P}_{c}}^{′} = \{ \begin{matrix}{P}_{g} & {P}_{c} > {P}_{g} \\ Δ P + {P}_{r} & {P}_{g} > {P}_{c} > {P}_{s} \\ {P}_{s} & {P}_{s} > {P}_{c}\end{matrix}$$

wherein P_{c}′ represents the actual output power command value; when the value of P_{c}′ is positive, the energy storage system enters a discharging state, and the system outputs power P_{c}′ externally; when the value of P_{c}′ is negative, the energy storage system enters a charging state, and the system consumes power |P_{c′}| externally.

It should be noted that in setting the frequency deadband constraint: the step defines a tolerable frequency deviation range (deadband), which prevents the energy storage system from frequently switching states due to minor fluctuations of the grid frequency, and in turn reduces system wear and operational costs. Constructing a power regulation value function: the power value to be regulated by the energy storage system is accurately calculated by analyzing the deviation between the real-time grid frequency and the rated frequency, and taking into account the frequency deadband constraint. the innovativeness of the step lies in that the output of the energy storage system can be dynamically regulated to respond to real-time changes in grid frequency, so that the response speed and the stability of the grid are improved.

S3: obtaining an actual output power command value based on a constraint function constructed from a theoretical power command value and a rated charging/discharging power value, and controlling the operation of the grid according to the actual output power command value.

Further, the upper and lower limits of the frequency are predetermined according to the design standards of the grid and the requirements for stable operation; the specific method comprises: determining the standard operation frequency of the grid according to the preset regional standards; calculating the tolerable frequency deviation range of the grid; and setting an upper limit and a lower limit of the frequency accordingly.

Further, the upper limit of the grid frequency is expressed by the formula as follows:

$${f}_{u} = {f}_{0} + ( Δ f + Λ {\sum }_{n = 1}^{N} {a}_{n} cos ( \frac{2 π nt}{T} + {ϕ}_{n} ) ) \cdot ( 1 + \frac{Γ ( {f}_{0} , L , C )}{1 + {e}^{- k ( L - {L}_{c} )}} )$$

Further, the lower limit of the grid frequency is expressed by the formula as follows:

$${f}_{d} = {f}_{0} - ( Δ f + Λ {\sum }_{n = 1}^{N} {a}_{n} cos ( \frac{2 π nt}{T} + {ϕ}_{n} ) ) \cdot ( 1 + \frac{Γ ( {f}_{0} , L , C )}{1 + {e}^{- k ( L - {L}_{c} )}} )$$

wherein f₀ represents the standard operation frequency of the grid as determined by the preset regional standards; Δf represents the basic frequency deviation range; Λ and aₙ represents the coefficients of the Fourier series, and is used for simulating the periodic regulation of the grid frequency caused by seasonal load variations; t represents the current measuring moment of the operation frequency; T represents the period duration; φₙ represents the phase shift, simulating the influence of different seasonal variations; L represents the real-time load; L_{c} represents the critical load value; C represents the proportion of renewable energy contribution in the current grid; and Γ(f₀,L,C) represents the chaotic mapping function, reflecting the combined influence of grid load and renewable energy contribution on frequency regulation.

Further, the chaotic manning function Γ is expressed by the formula as follows:

$$Γ ( {f}_{0} , L , C ) = {f}_{0} \cdot ( 1 - \frac{L}{{L}_{max}} ) \cdot ( 1 - C )$$

wherein Lₘₐₓ represents the maximum load that the grid can withstand.

It should be noted that in calculating the theoretical power command value and an actual output power command value: in the process, the power output of the energy storage system in the ideal condition is calculated, and an executable power command value is also obtained in accordance with the actual performance and limitations of the energy storage system. The strategy ensures that the energy storage system can support the grid frequency regulation to the maximum extent while protecting own safety and prolonging the service time;

S4: setting a hysteresis interval on the power command of the energy storage system, wherein when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

Further, the hysteresis interval comprises a hysteresis interval set on the power command of the energy storage system, the hysteresis interval defines a range within which the energy storage system does not respond to minor variations in power demand of the grid when switching between charging and discharging states, thereby avoiding frequent charge-discharge switching.

Further, the threshold of the hysteresis interval are predetermined according to the normal operation conditions of the grid and the performance characteristics of the energy storage system, the hysteresis interval is defined by setting two power thresholds: an upper threshold of the hysteresis interval for discharging and a lower threshold of the hysteresis interval for charging.

Further, the upper limit threshold of the discharging hysteresis interval is expressed by the formula as follows:

$${P}_{up} = {P}_{b} + δ \cdot ( 1 + \frac{sin ( w \cdot {t}_{0} + ϕ )}{1 + {e}^{- k \cdot ( P - {P}_{cr} )}} )$$

Further, the lower threshold of the charging hysteresis interval is expressed by the formula as follows:

$${P}_{low} = {P}_{b} - δ \cdot ( 1 + \frac{sin ( w \cdot {t}_{0} + ϕ )}{1 + {e}^{- k \cdot ( P - {P}_{cr} )}} )$$

wherein P_{b} represents the power reference value of the energy storage system when no regulation is required; δ represents the power regulation sensitivity coefficient set according to changes in grid demand; sin(w·t₀+φ) represents the periodic variation factor, wherein w represents the angular frequency, t₀ represents the current time, φ represents the phase difference, simulating the periodic variation of the grid load; k represents the regulation coefficient for nonlinear response; P represents the current power demand; and P_{cr} represents the critical power demand that triggers the power regulation response.

Further, when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

Further, the energy storage system maintains the current charging and discharging state within the hysteresis interval, and does not respond to minor fluctuations in power demand of the grid; when the power demand variation beyond the hysteresis interval is reached, the energy storage system smoothly switches between charging and discharging states at a predetermined rate, thus avoiding impact to the grid.

It should be noted that in smoothly switching between the charging and discharging states: the innovative use of a predetermined rate to the charging and discharging states of the energy storage system is smoothly switched creatively at a preset rate, and the impact of the operation on the energy storage system operation on grid stability is significantly reduced; the smooth switching mechanism ensures that the grid can obtain continuous and stable support when subjected to large-scale variations in power demand, thereby improving the reliability and resilience of the grid; with respect to the optimization of the grid frequency regulation service: the present invention provides the grid with more flexible and efficient frequency regulation services by precisely controlling the power output of the energy storage system; and while maintaining the stability of the grid frequency, the energy storage system can also meet the real-time needs of the grid.

On the other side, the embodiment also provides a system for participating in full range of charging and discharging of energy storage, comprising:
a data acquisition module, used for collecting data from real-time grid monitoring equipment, including grid frequency and the current power state of the energy storage system, the data being transmitted in real time to a data processing and analysis module;
a data processing and analysis module, used for processing and analyzing the collected data; calculating the full-range droop coefficient in real time and determining whether the energy storage system needs to adjust the power output to respond to changes in grid frequency at the moment. the module also calculating the theoretical power command value of the energy storage system under given conditions;
a control unit module, based on information provided by the data processing and analysis module, determining the optimal charging and discharging strategy, including how to smoothly switch the charging and discharging states of the energy storage system; the control strategy taking into account the actual grid demand, performance limitations of the energy storage system, and grid stability requirements; and
an energy storage and generation module, an executing module being used for adjusting the actual charging and discharging states of an energy storage system based on the command of a control strategy module, including adjusting the output power of an inverter connected to the grid and managing the energy flow in the energy storage system.

The above functions can be stored in a computer-readable storage medium, if implemented in the form of software functional units and sold or used as independent products. Based on such understanding, the technical scheme of the present invention essentially or part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of the specification, a “computer-readable medium” can be any apparatus that can contain, store, communicate, propagate, or transport the program for use by or in connection with an instruction execution system, apparatus, or device.

More specific examples (non-exhaustive list) of the computer-readable medium may include the following: an electrical connection (an electronic apparatus) with one or more wires, a portable computer disk case (a magnetic apparatus), a Random Access Memory (RAM), a Read-Only Memory (ROM), an Erasable Programmable Read-Only Memory (EPROM or flash memory), an optical fiber, and a portable Compact Disk Read-Only Memory (CDROM). Furthermore, the computer-readable medium may even be paper or other suitable media on which the program is printed, since the program may be obtained electronically, for example, by optically scanning paper or other media and then, if necessary, by editing, interpreting or processing in another suitable manner, and then storing in a computer memory.

It should be understood that, each part of the present invention may be realized by hardware, software, firmware or a combination thereof. In the above implementation manners, a plurality of steps or methods may be realized by software or firmware stored in the memory and executed by the appropriate instruction execution systems. For example, if implemented in hardware, as in another embodiment, it can be implemented using any one of the following technologies known in the art or a combination thereof: a discrete logic circuit having a logic gate circuit for implementing logic functions on data signals, a dedicated integrated circuit with suitable combined logic gate circuits, a programmable gate array (PGA), a field programmable gate array (FPGA), etc.

### Embodiment 2

The following is an embodiment of the present invention, providing a method for participating in grid frequency regulation within full range of charging and discharging of energy storage, so as to verify the beneficial effects of the present invention, and perform scientific validation via the calculation of economic benefits and the simulation experiments.

The rated generation power P_{g} value of certain energy storage system is 15 MW, and the rated charging power Pₛ is 10 MW, represented by the formula as −10 MW. According to the provisions of GB/T15945-1995 Quality of Electric Energy Supply—Permissible Deviation Of Frequency For Power System, the permissible deviation of the grid frequency is plus or minus 0.2 Hz, the nominal grid frequency f₀ is 50 Hz, the corresponding upper frequency limit fᵤ is 50.2 Hz, the lower frequency limit f_{d} is 49.8 Hz, then, the full-range droop coefficient ϵ can be calculated as 62.5.

The frequency regulation deadband generally refers to a frequency deviation set in a power system to prevent unnecessary actions of the system under minor fluctuations of the grid frequency. For example, in the case of a thermal power generating unit, the corresponding primary frequency regulation deadband is 0.033 Hz, then the upper limit of the frequency deadband Δᵤ is 50.033, and the lower limit of the frequency deadband Δ_{d} is 49.967.As a flexible regulating resource, the energy storage system can respond to the frequency regulation demand P_{c}′ of the grid by storing and releasing energy, where the actual output power command value needs to be calculated. Assuming that the real-time power Pᵣ is 12 MW.
(1) When the theoretical power command value P_{c} is 20 MW, larger than the rated generation power value P_{g}, the actual generation power rated value P_{c}′ is equal to the generation power rated value P_{g}:P_{c}′=P_{g}=15 MW, at the time, the energy storage system enters the discharging state, and the system outputs 15 MW externally.
(2) When the theoretical power command value P_{c} is 13 MW, between the rated generation power value P_{g} and the charging power rated value Pₛ, at the time, the regulation power value ΔP needs to be calculated based on the real-time frequency fᵣ.
\textcircled{1} When the real-time frequency value fᵣ is 50.1 Hz, which exceeds the upper limit value of the frequency deadband Δᵤ, the power regulation value ΔP is calculated as

$$Δ P = ∈ \times \frac{{f}_{r} - {f}_{0}}{{f}_{0}} \times {P}_{g} = 62.5 \times \frac{50.1 - 50}{50} \times 15 = 1.875 MW ,$$

the actual output power command P_{c}′ is equal to the power regulation value ΔP plus the real-time power value Pᵣ as: P_{c}′=1.875+12=13.875 MW, at the time, the energy storage system enters the discharging state, and the system outputs 13.875 MW externally.
\textcircled{2} When the real-time frequency value fᵣ is 50.01 Hz, between the upper and lower limits of the frequency deadband, the frequency regulation value ΔP is calculated as: ΔP=0, the actual output power command P_{c}′ is equal to the power regulation value ΔP plus the real-time power value Pᵣ as: P_{c}′=0+12=12 MW;
\textcircled{3} When the real-time frequency value fᵣ is 49.9 Hz, lower than the lower limit value Δ_{d} of the frequency deadband, the power regulation value ΔP is calculated as:

$$Δ P = ∈ \times \frac{{f}_{r} - {f}_{0}}{{f}_{0}} \times {P}_{s} = 62.5 \times \frac{49.9 - 50}{50} \times 10 = - 1.25 MW ,$$

the actual output power command P_{c}′ is equal to the power regulation value ΔP plus the real-time power value Pᵣ as: P_{c}′=−1.25+12=10.75 MW, at the time, the energy storage system enters the discharging state, and the system outputs 10.75 MW;
(3) When the theoretical power command value P_{c} is −12 MW, lower than the rated charging power Pₛ, the actual output power command P_{c}′ is equal to the rated charging power Pₛ:P_{c}′=−10 MW, at the time, the energy storage system enters the charging state, and the system consumes 10 MW externally.

It should be noted that the above embodiment is merely used for illustrating the technical scheme of the present invention instead of limitations thereto; although the present invention is illustrated in detail with reference to the optimal embodiments, those ordinary persons skilled in the art should understand that the technical scheme of the present invention can be modified or equivalently substituted without departing from the spirit and scope of the technical scheme of the present invention. Such modifications and substitutions are intended to be encompassed within the scope of the claims of the present invention.

What is claimed is:

1. A method for participating in grid frequency regulation within full range of charging and discharging of energy storage, wherein the method comprises:
collecting grid operation power and frequency data, and constructing a full-range droop coefficient;
setting constraints of upper and lower limits of a frequency deadband, obtaining a power regulation value according to the range of the real-time frequency, and calculating a theoretical power command value;
obtaining an actual output power command value based on the constraint function constructed from a theoretical power command value and a rated charging and generating power value, and controlling the operation of the grid according to the actual output power command value; and
setting a hysteresis interval on the power command of an energy storage system, wherein when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

2. The method for participating in grid frequency regulation within the full range of charging and discharging of energy storage according to claim 1, wherein the constructing the full-range droop coefficient comprises: collecting upper and lower limits of the grid operation frequency, recording rated generating power value of a generator and rated charging power value of a motor, and calculating the full-range droop coefficient, expressed by the formula as follows:
$$∈ = \frac{{\int }_{{f}_{d}}^{{f}_{u}} {e}^{∝ ( f - {f}_{ε} )} df}{{P}_{g} + {\sum }_{n - 1}^{N} \frac{{P}_{S}}{1 + {e}^{- β ( {f}_{n} - {f}_{0} )}}}$$
wherein ϵ represents the full-range droop coefficient; P_{g} represents the rated generating power value; Pₛ represents the rated charging power value; fᵤ represents the upper limit of the frequency; f_{d} represents the lower limit of the frequency; f represents the current grid frequency; f_{ε} represents
the frequency deviation from the rated frequency; e^{∝(f-f}^{₀}⁾ represents the regulation sensitivity; α represents the parameter regulating the growth rate of the exponential function;
$$\frac{{P}_{S}}{1 + {e}^{- β ( {f}_{n} - {f}_{0} )}}$$
represents the normalization function, simulating the nonlinear characteristic of the charging power varying with frequency; fₙ represents the frequency value of the segment n; and β represents the parameter regulating the steepness of the curve.

3. The method for participating in grid frequency regulation within the full range of charging and discharging of energy storage according to claim 2, wherein the power regulation value comprises a power regulation value retrieval function constructed using a real-time grid frequency value and a rated grid frequency value, with upper and lower limits of a frequency deadband as the constraint condition, expressed by the formula as follows:
$$Δ P = \{ \begin{matrix}∈ \times \frac{{f}_{r} - {f}_{0}}{{f}_{0}} \times {P}_{g} & {f}_{r} > {Δ}_{u} \\ 0 & {Δ}_{u} > {f}_{r} > {Δ}_{d} \\ ∈ \times \frac{{f}_{r} - {f}_{0}}{{f}_{0}} \times {P}_{s} & {Δ}_{d} > {f}_{r}\end{matrix}$$
wherein ΔP represents the power regulation value; fᵣ represents the real-time frequency value; f₀ represents the rated frequency value; Δᵤ represents the upper limit of the frequency deadband; Δ_{d} represents the lower limit of the frequency deadband;
when value of ΔP is positive, the power is increased; and when the value of ΔP is negative, the power is decreased.

4. The method for participating in grid frequency regulation within the full range of charging and discharging of energy storage according to claim 3, wherein the actual output power command value comprises: obtaining the actual output power command value based on a constraint function constructed from the theoretical power command value and the rated charging and generating power value, and controlling the operation of the grid according to the actual output power command value;
the formula for calculating the theoretical power command value being expressed as:
$${P}_{c} = Δ P + {P}_{r}$$
wherein P_{c} represents the theoretical power command value; and Pᵣ represents the real-time power value;
and performing determination to obtain the real output power command value, expressed by the formula as follows:
$${P}_{c}^{′} = \{ \begin{matrix}{P}_{g} & {P}_{c} > {P}_{g} \\ Δ P + {P}_{r} & {P}_{g} > {P}_{c} > {P}_{s} \\ {P}_{s} & {P}_{s} > {P}_{c}\end{matrix}$$
wherein P_{c}′ represents the actual output power command value; when the value of P_{c}′ is positive, the energy storage system enters a discharging state, and the system outputs power P_{c}′ externally; when the value of P_{c}′ is negative, the energy storage system enters a charging state, and the system consumes power |P_{c}| externally.

5. The method for participating in grid frequency regulation within the full range of charging and discharging of energy storage according to claim 4, wherein the upper and lower limits of the frequency are predetermined according to the design standards of the grid and the requirements for stable operation; a specific method comprising: determining the standard operation frequency of the grid according to the preset regional standards; and calculating the tolerable frequency deviation range of the grid, and setting upper and lower limits of the frequency accordingly;
the upper limit of the grid frequency being expressed by the formula as follows:
$${f}_{u} = {f}_{0} + ( Δ f + Λ {\sum }_{n = 1}^{N} {a}_{n} cos ( \frac{2 π n t}{T} + {ϕ}_{n} ) ) \cdot ( 1 + \frac{Γ ( {f}_{0} , L , C}{1 + {e}^{- k ( L - {L}_{c} )}} )$$
the lower limit of the grid frequency being expressed by the formula as follows:
$${f}_{d} = {f}_{0} - ( Δ f + Λ {\sum }_{n = 1}^{N} {a}_{n} cos ( \frac{2 π n t}{T} + {ϕ}_{n} ) ) \cdot ( 1 + \frac{Γ ( {f}_{0} , L , C}{1 + {e}^{- k ( L - {L}_{c} )}} )$$
wherein f₀ represents the standard operation frequency of the grid as determined by the preset regional standards; Δf represents the basic frequency deviation range; Λ and aₙ represents the coefficients of the Fourier series, and is used for simulating the periodic regulation of the grid frequency caused by seasonal load variations; t represents the current measuring moment of the operation frequency; T represents the period duration; φₙ represents the phase shift, simulating the influence of different seasonal variations; L represents the real-time load; L_{c} represents the critical load value; C represents the proportion of renewable energy contribution in the current grid; and Γ(f₀,L,C) represents the chaotic mapping function, reflecting the combined influence of grid load and renewable energy contribution on frequency regulation;
the chaotic mapping function Γ being expressed by the formula as follows:
$$Γ ( {f}_{0} , L , C ) = {f}_{0} \cdot ( 1 - \frac{L}{{L}_{max}} ) \cdot ( 1 - C )$$
wherein Lₘₐₓ represents the maximum load that the grid can withstand.

6. The method for participating in grid frequency regulation within the full range of charging and discharging of energy storage according to claim 5, wherein the hysteresis interval comprises a hysteresis interval further set on the power command of the energy storage system, the hysteresis interval defining a range within which the energy storage system does not respond to minor variations in power demand of the grid when switching between charging and discharging states, thereby avoiding frequent charge-discharge switching;
the threshold of the hysteresis interval being predetermined according to the normal operation conditions of the grid and the performance characteristics of the energy storage system, and the hysteresis interval being defined by setting two power thresholds, i.e., an upper threshold of the hysteresis interval for discharging and a lower threshold of the hysteresis interval for charging;
the upper limit threshold of the discharging hysteresis interval being expressed by the formula as follows:
$${P}_{up} = {P}_{b} + δ \cdot ( 1 + \frac{sin ( w \cdot {t}_{0} + ϕ )}{1 + {e}^{- k \cdot ( P - {P}_{cr} )}} )$$
the lower threshold of the charging hysteresis interval being expressed by the formula as follows:
$${P}_{low} = {P}_{b} - δ \cdot ( 1 + \frac{sin ( w \cdot {t}_{0} + ϕ )}{1 + {e}^{- k \cdot ( P - {P}_{cr} )}} )$$
wherein P_{b} represents the power reference value of the energy storage system when no regulation is required; δ represents the power regulation sensitivity coefficient set according to changes in grid demand; sin(w·t₀+φ) represents the periodic variation factor, w represents the angular frequency, t₀ represents the current time, φ represents the phase difference, simulating the periodic variation of the grid load; k represents the regulation coefficient for nonlinear response; P represents the current power demand; and P_{cr} represents the critical power demand that triggers the power regulation response;
wherein when the power demand of the grid exceeds the upper threshold of the hysteresis interval, the energy storage system switches from the charging mode to the discharging mode; and when the power demand of the grid falls below the lower threshold of the hysteresis interval, the energy storage system switches from the discharging mode to the charging mode.

7. The method for participating in grid frequency regulation within the full range of charging and discharging of energy storage according to claim 6, wherein the energy storage system maintains the current charging and discharging state within the hysteresis interval, and does not respond to minor fluctuations in power demand of the grid; and
when the power demand variation beyond the hysteresis interval is reached, the energy storage system smoothly switches between charging and discharging states at a predetermined rate, thus avoiding impact to the grid.

8. A system for participating in grid frequency regulation within full range of charging and discharging of energy storage using the method according to claim 7, comprising:
a data acquisition module, used for collecting data from real-time grid monitoring equipment, including grid frequency and the current power state of the energy storage system, the data being transmitted in real time to a data processing and analysis module;
the data processing and analysis module, used for processing and analyzing the collected data; calculating the full-range droop coefficient in real time and determining whether the energy storage system needs to adjust the power output to respond to changes in grid frequency at the moment; the module also calculating the theoretical power command value of the energy storage system under given conditions;
a control unit module, used for determining the optimal charging and discharging strategy based on information provided by the data processing and analysis module, including how to smoothly switch the charging and discharging states of the energy storage system; the control strategy taking into account the actual grid demand, performance limitations of the energy storage system, and grid stability requirements; and
an energy storage and generation module, an executing module being used for adjusting the actual charging and discharging states of an energy storage system based on the command of a control strategy module, including adjusting the output power of an inverter connected to the grid and managing the energy flow in the energy storage system.

9. A computer device, comprising a memory and a processor, the memory stores a computer program, wherein the processor implements the steps in the method for participating in grid frequency regulation within full range of charging and discharging of energy storage when executing the computer program.

10. A computer-readable storage medium, on which a computer program is stored, wherein the computer program, when executed by the processor, implements the steps in the method for participating in grid frequency regulation within full range of charging and discharging of energy storage.
